(19) United States
(12) Patent Application Publication
(10) Pub. No.: US 2015/0068675 A1
(43) Pub. Date: Mar. 12, 2015

(54) METHOD FOR PROTECTING OUTDOOR ENVIRONMENT DISPLAY SCREENS AND MEMBRANE KEYPADS

(71) Applicants: Derek Zahajko, Maple Valley, WA (US); Michael Zahajko, Maple Valley, WA (US)

(72) Inventors: Derek Zahajko, Maple Valley, WA (US); Michael Zahajko, Maple Valley, WA (US)

(21) Appl. No.: 14/483,460

(22) Filed: Sep. 11, 2014

Related U.S. Application Data
(60) Provisional application No. 61/876,271, filed on Sep. 11, 2013.

(51) Int. Cl. B32B 37/12; B32B 38/08; B32B 37/18

(52) U.S. Cl. CPC B32B 37/1284; B32B 37/18; B32B 38/08; B32B 2457/20; B32B 2457/00; B32B 2571/00
USPC 156/278; 156/60

(57) ABSTRACT

A method of protecting electronic display touch screens, keyboards and membrane switches on outdoor installation such as fuel dispensers and ATMs by covering them with a protective film piece cut to size and affixed thereto.

### CROSS REFERENCE TO RELATED APPLICATIONS

This application claims the benefit of U.S. provisional application no. 61/876,271 filed on Sep. 11, 2013.

### FIELD OF THE INVENTION

The present invention relates generally to protection for exposed display screens and membrane keypads, on outdoor equipment such as fuel dispensers, ATM's, kiosks and other equipment generally exposed to outdoor environments.

### BACKGROUND OF THE INVENTION

The use of protective films of various types to protect electronic devices has been an accepted practice to prevent or minimize wear and tear damage to the device. In general, currently available protective films are designed for use indoors or for electronics maintained on one's person. There has heretofore no effective protection for display and touch screens and membrane keyboards on exterior equipment.

In particular, the environment typically around of a gas station is sufficiently harsh such that common adhesives fail to maintain their hold for a long duration. Specifically, long-term exposure to elements such as gasoline vapors, direct sunlight, extreme hot or cold temperature, strong winds, and physical abrasion from cleaning causes degradation of display and touch screens and keyboards.

Outdoor equipment is also commonly damaged through a variety of other ways that could be prevented by suitable means, i.e. by intentional vandalism by scratching, etching or other intentional marking directly to the surface often occurs. Second, simple wear and tear, or use, of the device causes visible wear or even holes through surfaces by extensive contact of user's fingers. Long-term exposure to direct sunlight, UV rays causes yellowing or other degradation of these surfaces.

Furthermore, the numerous outdoor equipment manufacturers each provide variously uniquely sized and configured surfaces in need of protection which complicates any efforts.

Therefore, it is an object of the present invention to provide a suitable protection for the aforementioned display and touch screens and membrane keyboards is an outdoor environment.

### SUMMARY OF THE INVENTION

The above recited object and other objects which will be understood upon a reading of the following specification and claims are achieved by applying a suitable protective film durable in outdoor environments on surfaces such as screens, keypads, membranes etc.

The protective film is adhered to the surfaces to prevent the aforementioned damages resulting from vandalism, wear and tear, and prolonged environmental exposure damage.

To prevent vandalism, wear and tear, and exposure damage it is imperative to provide both sufficient protection from the aforementioned sources of damage as well as adequate adhesion to endure prolonged exposure to outdoor environments. Furthermore, it is necessary for the film to be readily removed in the event of damage to the film without damaging or leaving a residue on the underlying surface.

It has been discovered that there is commercially available film for use to cover windows to reduce penetration by solar radiation through the windows which is effective as a protective measure against damage to electronic display and touch screens, membrane switches and keyboards, etc. in an exterior environment and is capable of withstanding sustained exposure to the outdoor environment.

In one embodiment, for screens or similar applications where there exists an inflexible surface, a rigid film is cut specifically to the desired size of the underlying surface.

In one embodiment, for keypad membrane or similar applications where surface movement is to be expected, a flexible matte film is cut specifically to the desired size of the treatment area.

In all embodiments, proper sizing is essential to adequate protection. When the film is too large, proper adhesion to the surface is jeopardized as debris and the elements can get under the film and promote further degradation of the adhesion. When the film is too small, the original surface is exposed to possible damage. Because standard sizes for screens, keypads and membranes do not exist for outdoor equipment, careful measurements of sizes and corner radiuses is required.

The protective film is applied to the surface through a wet application. A wet application requires the wetting of both the application surface as well as the back side of the protective film. A wetting solution may consist of water and a light surfactant. Once applied, a squeegee is used to remove excess solution between layers, and set the adhesive.

Since this product is being applied to screens and surfaces that are frequently touched in public settings, they may be prone to hosting viruses, disease, etc. the surface may be located with an anti-microbial agent or process that would prohibit viruses, disease, etc from “living” on the surface.

In another embodiment a faint printing is added (using etching, watermarking or other technique) to “brand” the surface of the film with the purpose of promoting a brand.

This would be a new available for a gas station to provide advertising space on to a potential brand.

The “printing” is faint enough so the underlying screen or keypad would still be usable, but is distinct enough to allow persons to view the brand or from specific angles.

### BRIEF DESCRIPTION OF DRAWINGS

FIG. 1 is a pictorial view of a fuel dispenser with protective film pieces installed on a display screen and membrane switches.

FIG. 2 is an fragmentary pictorial view of an ATM machine with protective film on a display screen and in membrane switches.

FIG. 3 is a pictorial view of a protective film being installed on a display screen.

FIG. 4A is a fragmentary pictorial view of a fuel dispenser display screen being prepared for installation of a protective file piece.

FIG. 4B is a pictorial view of a protective film piece with a liner backing being peeled off to expose an adhesive coating on one side.

FIG. 4C is a pictorial view of protective film piece with the adhesive side being sprayed with water.

FIG. 4D is a fragmentary pictorial view of a fuel dispenser showing installation of a protective film on a display screen.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

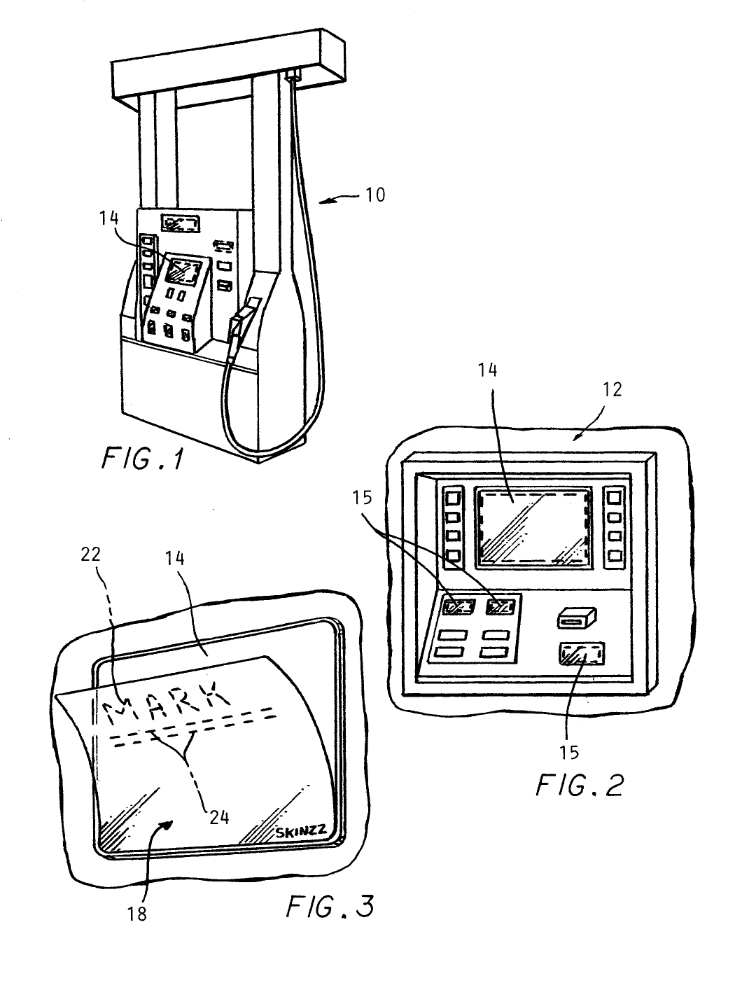

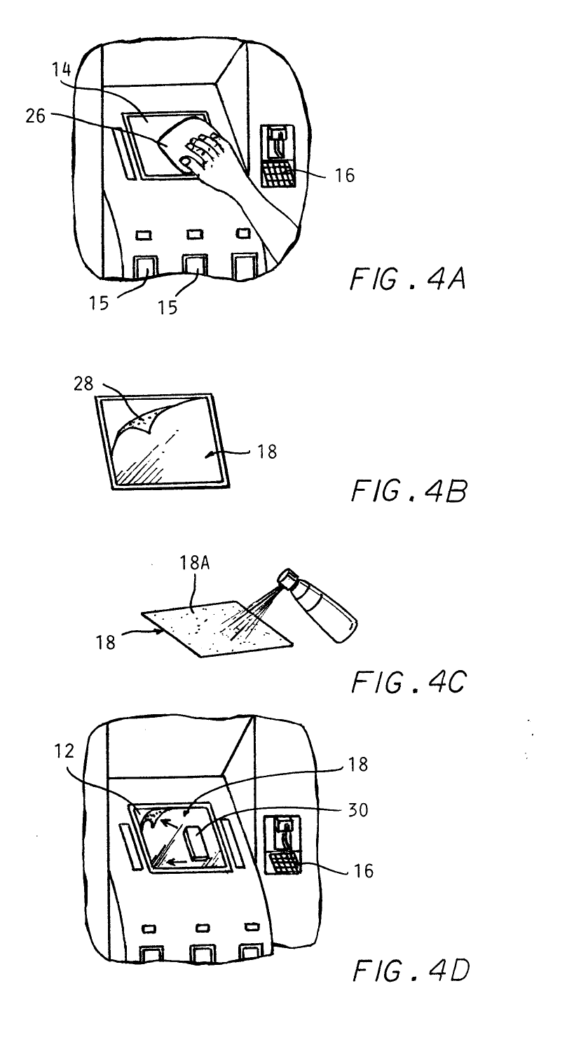

Referring to the drawings the method of the invention involves the installation of protective film pieces 18 over touch and ion display screens 14 (FIGS. 1, 2) as well as touch membrane switches 15, membrane keyboards 16 (FIG. 4A), in an outdoor environment such as on fuel dispensers 10 (FIG. 1) and ATM machines 12 (FIG. 2), and the like. Such film pieces must resist weather condition and other environmental conditions.

It has been determined that commercially available protective films used in the past on windows to block solar radiation will perform satisfactorily in practicing the present invention.

An example of such film is sold under the trademark Solar Gard™ by Saint Gobain Performance Plastics Solar-Gard International Inc., of North ?????, Florida, a Florida corporation.

Such film has adhesive preapplied to one surface and typically a lining sheet is adhered thereto which is removed in preparation for installation.

Each protective film piece 18 should be cut to be closely matched to the area to be covered in order to avoid any loose border areas which would capture dirt, moisture, etc. and tend to degrade the bond.

According to one aspect of the invention shown in FIG. 3, the protective film piece 18 can have a trademark 22 and advertising copy 24 imprinted thereon in a faint see through form to enable a service station owner to realize an income from advertisers.

According to another aspect thereof, germicidal material can be applied to the exposed surface of the protective film piece 18 to minimize the spread of germs by the touching of large numbers of people.

Installation would involve the following steps:

1. Clean and remove all dust and dirt from surface with the application solution of water and mild surfactant (soap, etc), and a clean, low-lint cloth 26. Use OTIS multi-surface cleaner to remove heavy grease or grim, making sure to clean debris from the edges of the application area (FIG. 4A).

2. Peel away the lining 28 to expose the adhesive backing while avoiding touching the protective film piece 18 adhesive side 18A (FIG. 4B).

3. Spray the application solution of water and mild surfactant to the adhesive side (FIG. 4C).

4. Center the protective film piece 18 on the area to be covered, and use a squeegee (not shown) stroked across to remove excess application solution and air bubbles from under the protective film piece 18. Use a cloth 30 to soak up excess solution around film piece edges (FIG. 4D).

For best results, this wet application should be used for all keyboards and display screen applications.

1. A method of protecting the surface touch and/or display screens, membrane switches and keyboards or the like surfaces in an outdoor environment on fuel dispensers, ATMs and the like comprising installing a protective film in place over said surfaces which is resistant to the outdoor environment conditions.

2. The method according to claim 1 including covering the side of said protective film piece against the surface with a solution of water mixed with a mild surfactant before placing it over the surface and smoothing the opposite outer side with a squeegee after emplacement on said surface.

3. The method according to claim 1 further including faintly imprinting advertising on said protective film piece.

4. The method according to claim 2 further including coating said opposite side with a germicidal material.
